(19) United States
(12) Patent Application Publication
(10) Pub. No.: US 2009/0298454 A1
(43) Pub. Date: Dec. 3, 2009

(54) RECEIVER

(75) Inventors: Takeshi Ikeda, Tokyo (JP); Hiroshi Miyagi, Yokohama-shi (JP)

Correspondence Address: CONNOLLY BOVE LODGE & HUTZ LLP, 1875 EYE STREET, N.W., SUITE 1100, WASHINGTON, DC, 20006, US

(73) Assignees: Niigata Seimitsu Co., Ltd., Jyoetsu-shi (JP); Ricoh Co., Ltd., Tokyo (JP)

(21) Appl. No.: 12/295,912

(22) PCT Filed: Nov. 8, 2006
(86) PCT No.: PCT/JP2006/322686

§ 371 Date: Oct. 3, 2008

(30) Foreign Application Priority Data
Apr. 4, 2006 (JP) 2006-102631

(51) Int. Cl. H04B 1/16; H04B 1/26

(52) U.S. Cl. 455/234.1; 375/345; 455/313; 455/251.1

(57) ABSTRACT

By A/D converting a signal output from a mixer (4) and inputting the A/D converted signal to a DSP (8), and generating AGC control data (D_{L}) corresponding to a level of the signal to control a gain of an LNA (3) in such a manner that a voltage input to an A/D converting circuit (7) is lower than a full scale voltage of the A/D converting circuit (7), it is possible to prevent a signal having an excessively high level beyond a dynamic range of the A/D converting circuit (7) from being input to the A/D converting circuit (7). By controlling the gain of the LNA (3) corresponding to a level of a broad band signal before passing through a BPF (11) and controlling a gain of an IF amplifier (12) corresponding to a level of a narrow band signal after passing through the BPF (11), moreover, it is possible to properly control a gain of an AGC as a whole in consideration of signal levels of both a desirable wave and a disturbing wave.

### FIELD OF THE INVENTION

The present invention relates to a receiver and more particularly to a receiver having an automatic gain control function for inhibiting a distortion of a signal from being occurred when the signal is input having a high level.

### DESCRIPTION OF THE RELATED ART

In general, a wireless communication apparatus such as a radio receiver is provided with an AGC (Automatic Gain Control) circuit for controlling a gain of a received signal. FIG. 1 is a diagram showing a structure of a conventional radio receiver including an AGC circuit. As shown in FIG. 1, the conventional radio receiver includes an antenna 101, a band-pass filter 102, an LNA (Low Noise Amplifier) 103, a frequency mixing circuit 104, a local oscillating circuit 105, band-pass filters 106 and 107, an intermediate frequency amplifying circuit (IF amplifier) 108, a demodulating circuit 109, and AGC circuits 110 and 111.

The band-pass filter 102 selectively outputs broadcast wave signals in a specific frequency band from broadcast wave signals received by the antenna 101. The band-pass filter 102 has a comparatively broad pass band and causes broadcast wave signals in several to a dozen or so stations to pass therethrough. The LNA 103 amplifies the signal passing through the band-pass filter 102 with a low noise. A gain (an amplifying gain) of the LNA 103 is controlled corresponding to a control voltage V_{L} supplied from the first AGC circuit 110. A voltage value for giving a maximum gain to the LNA 103 is usually set. When a signal having an excessively high level is input, the gain of the LNA 103 is reduced.

A signal amplified by the LNA 103 is supplied to the frequency mixing circuit 104. The frequency mixing circuit 104 constitutes a frequency converting circuit together with the local oscillating circuit 105. The frequency converting circuit mixes a high frequency signal output from the LNA 103 and a local oscillating signal output from the local oscillating circuit 105 by the frequency mixing circuit 104 and carries out a frequency conversion to generate and output an intermediate frequency signal.

The band-pass filter 106 connected to a subsequent stage of the frequency mixing circuit 104 has an intermediate pass band and carries out a band limitation over an intermediate frequency signal output from the frequency mixing circuit 104 to generate an intermediate frequency signal in an intermediate band including a desirable frequency. Moreover, the band-pass filter 107 in a subsequent stage has a narrow pass band and is used for extracting an intermediate frequency signal in a narrow band including only one station of the desirable frequency.

The IF amplifier 108 amplifies an intermediate frequency signal having a desirable wave which is output from the band-pass filter 107. A gain of the IF amplifier 108 is controlled corresponding to a control voltage V_{I} supplied from the second AGC circuit 111. A voltage value for giving a maximum gain to the IF amplifier 108 is usually set. When an excessively high level signal which is not sufficient even by a reduction in the gain of the LNA 103 is input, the gain of the IF amplifier 108 is decreased.

Thus, the gains of the LNA 103 and the IF amplifier 108 are controlled so that an overall noise factor (NF) from the LNA 103 to the IF amplifier 108 is always set to be equal to or lower than a predetermined level. The structure for carrying out the AGC processing for both the LNA 103 and the IF amplifier 108 has also been disclosed in Patent Document 1, for example.

Patent Document 1: Japanese Laid-Open Patent Publication No. 2001-136447

The demodulating circuit 109 demodulates an intermediate frequency signal output from the IF amplifier 108 into a baseband signal and outputs the baseband signal. The first AGC circuit 110 detects a signal output from the frequency mixing circuit 104 (which includes a disturbing wave in addition to a desirable wave) to extract a DC component and supplies the DC component as the AGC control voltage V_{L} to the LNA 103. Moreover, the second AGC circuit 111 detects a signal output from the IF amplifier 108 (which includes only the desirable wave) to extract a DC component and supplies the DC component as the AGC control voltage V_{I} to the IF amplifier 108.

There has also been disclosed a structure in which the processing for demodulating the intermediate frequency signal and the AGC processing are executed as digital signal processings through a DSP (Digital Signal Processor) (for example, see Patent Documents 2 and 3). In FIG. 1 of the Patent Document 2 (the prior art), the AGC processing of the IF amplifier is executed by using the DSP. In the Patent Document 3, moreover, the AGC processings of the RF amplifier and the IF amplifier are executed by using the DSP. By executing the AGC processing through the DSP, it is possible to carry out a stable AGC processing without complicating the structure of the circuit even if a source voltage or an IC process is changed.

Patent Document 2: Japanese Laid-Open Patent Publication No. 11-136153

Patent Document 3: Japanese Laid-Open Patent Publication No. 2000-209118

Moreover, the Patent Document 2 has also disclosed a device capable of executing a demodulation processing corresponding to a fluctuation in a signal level within a wide range without using the AGC processing. More specifically, a signal output from an IF amplifier is A/D converted and the A/D converted signal is supplied to the DSP, and furthermore, a signal output from a frequency converter provided in a previous stage of the IF amplifier is A/D converted and the A/D converted signal is supplied to the DSP, and the DSP selects any of the A/D converted outputs to execute a demodulation processing.

This is carried out in consideration of the following. When an excessively high level signal beyond a dynamic range of the A/D converter is input, a digitization cannot be accurately executed by the A/D converter. For this reason, a demodulation processing cannot be performed accurately through software using the DSP. In other words, a processing system for A/D converting a signal output from the frequency converter and supplying the A/D converted signal to the DSP is selected in case of a received signal having a high level beyond the dynamic range of the A/D converter, and a processing system for A/D converting a signal output from the IF amplifier and supplying the A/D converted signal to the DSP is selected in the case in which the received signal has a low level.

### DISCLOSURE OF THE INVENTION

In the technique described in the Patent Document 2, however, it is necessary to provide two routes, that is, a route for supplying a signal from a first A/D converter to the DSP via the IF amplifier and a route for supplying the signal from a second A/D converter to the DSP without passing through the IF amplifier in order to execute the demodulation processing corresponding to a fluctuation in the signal level within a wide range. For this reason, there is a problem in that two A/D converters are required for accurately executing the demodulation processing through the DSP.

On the other hand, in the technique described in the Patent Document 3, although a single A/D converter is enough, a level of a signal having only a desirable wave after a passage through the IF filter is detected to control gains of an RF amplifier and an IF amplifier. Gains of an RFAGC and an IFAGC are independently changed respectively through an arithmetic circuit of the DSP. However, a signal level of a desirable wave (a narrow band) is a reference of a gain control to the end and a signal level in a broad band including a disturbing wave is not taken into consideration. For this reason, there is a problem in that a gain control considering a level of the disturbing wave is insufficient and the gain of the AGC is not always controlled properly.

In order to solve the problems, it is an object of the present invention to accurately execute a demodulation processing through a digital signal processing without providing two A/D converting circuits and to properly control a gain of an AGC in consideration of both a signal level in a narrow band and a signal level in a broad band.

In order to attain the object, a receiver according to the present invention A/D converts a signal in a broad band and inputs the A/D converted signal to a digital signal processing circuit, and generates first control data for controlling a gain of a high frequency amplifying circuit through a digital signal processing based on a level of the signal in the broad band. Based on the first control data, a voltage input to an A/D converting circuit is set to be lower than a full scale voltage of the A/D converting circuit. Moreover, a signal in a narrow band is generated in the digital signal processing circuit and second control data for controlling a gain of intermediate frequency amplifying means constituted as the digital signal processing circuit are generated through the digital signal processing based on a level of the signal in the narrow band.

According to the present invention having the structure described above, the gain of the high frequency amplifying circuit is controlled in such a manner that a signal having an excessively high level beyond a dynamic range of the A/D converting circuit is not input to the A/D converting circuit. Consequently, it is not necessary to provide a processing system in another route to prepare for the case in which a received signal having a high level is input, and two A/D converting circuits do not need to be provided. More specifically, it is possible to accurately execute the demodulation processing through the digital signal processing without providing the two A/D converting circuits.

According to the present invention, moreover, a gain is controlled by using both first control data generated by detecting a level of a signal in a broad band (including both a desirable wave and a disturbing wave) and second control data generated by detecting a level of a signal in a narrow band (only the desirable wave). Consequently, it is possible to properly control the gain of the AGC as a whole in consideration of both the signal level in the narrow band and the signal level in the broad band.

### BRIEF DESCRIPTION OF THE DRAWINGS

FIG. 1 is a diagram showing a structure of a conventional radio receiver,

FIG. 2 is a diagram showing an example of a structure of a radio receiver according to a first embodiment, and

FIG. 3 is a diagram showing an example of a structure of a radio receiver according to a second embodiment.

### BEST MODE FOR CARRYING OUT THE INVENTION

### First Embodiment

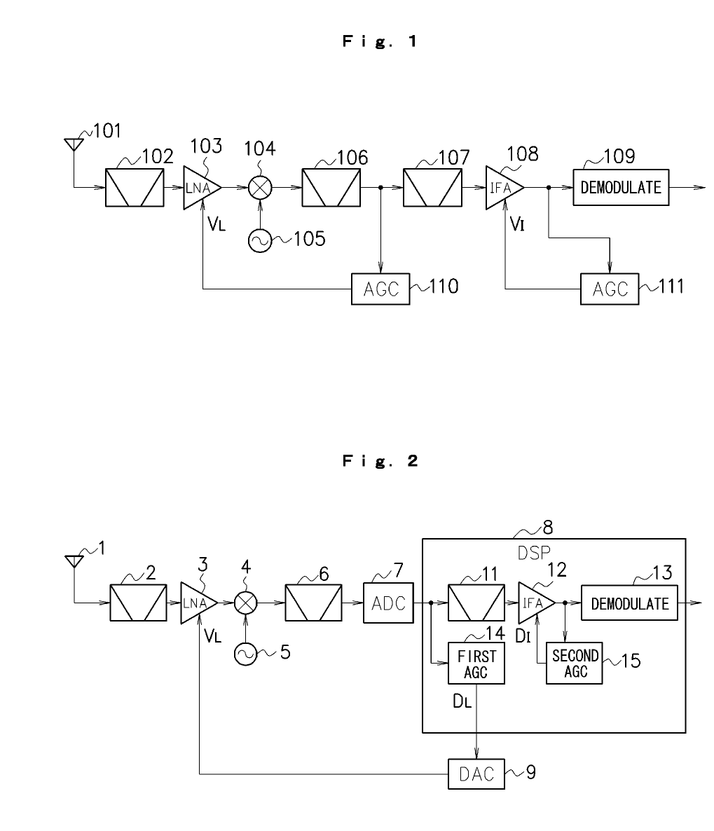

An embodiment according to the present invention will be described below with reference to the drawings. FIG. 2 is a diagram showing an example of a structure of a radio receiver according to a first embodiment. As shown in FIG. 2, the radio receiver according to the first embodiment includes an antenna 1, a band-pass filter 2, an LNA 3, a frequency mixing circuit 4, a local oscillating circuit 5, an antialiasing filter 6, an A/D converting circuit 7, a DSP 8, and a D/A converting circuit 9. These structures (excluding the antenna 1) are integrated in a single semiconductor chip through a CMOS (Complementary Metal Oxide Semiconductor) process, for example.

Moreover, the DSP 8 includes a band-pass filter 11 (corresponding to filter means according to the present invention), a digital IF amplifier 12 (corresponding to intermediate frequency amplifying means according to the present invention), demodulating means 13, first AGC means 14 (corresponding to first automatic gain control means according to the present invention), and second AGC means 15 (corresponding to second automatic gain control means according to the present invention) as functional structures implemented by a digital signal processing.

The band-pass filter 2 selectively outputs broadcast wave signals in a specific frequency band from broadcast wave signals received by the antenna 1. The band-pass filter 2 has a comparatively broad pass band and causes broadcast wave signals in several to a dozen or so stations to pass therethrough. The LNA 3 corresponds to a high frequency amplifying circuit and high frequency amplifying means according to the present invention, and amplifies a high frequency signal passing through the band-pass filter 2 with a low noise. A gain (an amplifying gain) of the LNA 3 is controlled corresponding to a control voltage V_{L} supplied from the D/A converting circuit 9. A voltage value for giving a maximum gain to the LNA 3 is usually set. When a signal having an excessively high level is input, the gain of the LNA 3 is reduced.

A signal amplified by the LNA 3 is supplied to the frequency mixing circuit 4. The frequency mixing circuit 4 constitutes a frequency converting circuit according to the present invention together with the local oscillating circuit 5. The frequency converting circuit mixes a high frequency signal output from the LNA 3 and a local oscillating signal output from the local oscillating circuit 5 by the frequency mixing circuit 4 and carries out a frequency conversion to generate and output an intermediate frequency signal. The antialiasing filter 6 removes the aliasing frequency for A/D converter occurred by the frequency conversion. The antialiasing filter 6 is constituted by a band-pass filter or a low-pass filter, for example. The antialiasing filter 6 is not essential but is preferably provided.

The A/D converting circuit 7 analog-digital converts the intermediate frequency signal output from the antialiasing filter 6. The intermediate frequency signal thus changed into digital data is input to the DSP 8. The band-pass filter 11 in the DSP 8 executes a filter processing for the intermediate frequency signal supplied from the A/D converting circuit 7. The band-pass filter 11 has a narrow pass band. An intermediate frequency signal in a narrow band (having a desirable wave) including only one station of a desirable frequency is extracted by the band-pass filter 11.

The digital IF amplifier 12 amplifies the intermediate frequency signal of the desirable wave which is output from the band-pass filter 11. A gain of the digital IF amplifier 12 is controlled corresponding to control data D_{I} supplied from the second AGC means 15. A control value for giving a maximum gain to the digital IF amplifier 12 is usually set. When an excessively high level signal which is not sufficient even by a reduction in a gain of the LNA 3 is input, the gain of the digital IF amplifier 12 is decreased. The demodulating means 13 demodulates the intermediate frequency signal output from the digital IF amplifier 12 into a baseband signal and outputs the baseband signal.

The first AGC means 14 detects a level of the intermediate frequency signal (including a disturbing wave in addition to a desirable wave) output from the A/D converting circuit 7 and generates first control data D_{L} for controlling the gain of the LNA 3 corresponding to the detected level. The D/A converting circuit 8 digital-analog converts the control data D_{L} into the control voltage V_{L} and supplies the control voltage V_{L} to the LNA 3. The first AGC means 14 controls the gain of the LNA 3 in such a manner that a voltage input to the A/D converting circuit 7 is lower than a full scale voltage of the A/D converting circuit 7.

In order to enhance a responding performance of the AGC processing using the first AGC means 14, it is preferable to use the A/D converting circuit 7 having a high resolution (bit precision) and to use the first AGC means 14 having a small time constant. In the present embodiment, the first AGC means 14 is implemented by the digital signal processing. Therefore, it is possible to reduce the time constant sufficiently. If the bit precision of the A/D converting circuit 7 is higher than 10 bits, moreover, the A/D converting circuit 7 is fit for a practical use. In order to take a margin, 12 to 14 bit precision is preferably set.

The second AGC means 15 detects a level of the intermediate frequency signal (having only a desirable wave) output from the digital IF amplifier 12, and generates the second control data D_{I} for controlling the gain of the digital IF amplifier 12 corresponding to the detected level and supplies the control data D_{I} to the digital IF amplifier 12. Although the level of the signal output from the digital IF amplifier 12 is detected, it is effective for the case of an FM broadcasting receipt. In case of an AM broadcasting receipt, it is also possible to detect a level of a signal output from the demodulating means 13.

As described above, in the first embodiment, the intermediate frequency signal generated by the frequency converting circuit is A/D converted through the A/D converting circuit 7 and is input to the DSP 8. Then, the control data D_{L} for controlling the gain of the LNA 3 are generated by the digital signal processing, and are D/A converted and are supplied to the LNA 3 to control the voltage input to the A/D converting circuit 7 so as to be lower than the full scale voltage of the A/D converting circuit 7.

Consequently, a signal having an excessively high level beyond the dynamic range of the A/D converting circuit 7 is prevented from being input to the A/D converting circuit 7. Accordingly, it is not necessary to provide another processing system to prepare for the case in which a received signal having a high level is input. Therefore, two A/D converting circuits do not need to be provided. Therefore, it is possible to accurately execute the demodulation processing through the digital signal processing by using the intermediate frequency signal which is accurately digitized by the A/D converting circuit 7 without providing the two A/D converting circuits.

In the present embodiment, moreover, the gain of the LNA 3 is controlled corresponding to the level of the intermediate frequency signal in the broad band before passing through the band-pass filter 11 and the gain of the digital IF amplifier 12 is controlled corresponding to the level of the intermediate frequency signal in the narrow band after passing through the band-pass filter 11. Consequently, the gains of the LNA 3 and the digital IF amplifier 12 are properly controlled corresponding to the level of the intermediate frequency signal in the broad band including both the desirable wave and the disturbing wave in addition to the intermediate frequency signal in the narrow band including only the desirable wave. Therefore, it is possible to properly control the gain of the AGC as a whole in consideration of both the signal level in the narrow band and the signal level in the broad band.

In the present embodiment, furthermore, the function of the digital IF amplifier 12 is also implemented by the digital signal processing of the DSP 8. For this reason, it is not necessary to provide an IF amplifier as an analog circuit. Consequently, it is possible to reduce a chip size and to lessen a consumed current. When the IF amplifier is provided as the analog circuit, moreover, it can serve as a noise source by itself By eliminating the IF amplifier of the analog circuit, however, it is possible to decrease the noise source.

### Second Embodiment

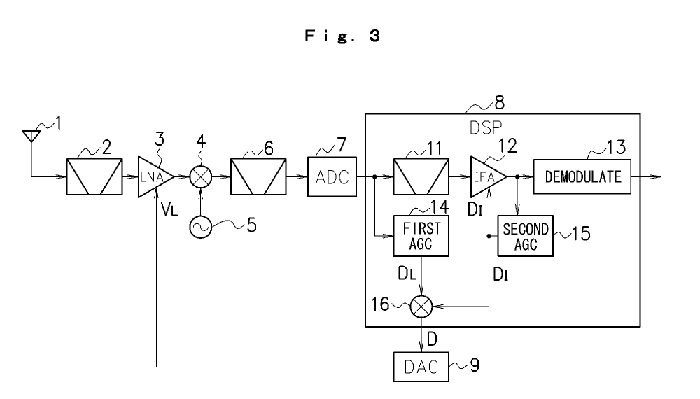

Next, a second embodiment according to the present invention will be described. FIG. 3 is a diagram showing an example of a structure of a radio receiver according to the second embodiment. In FIG. 3, portions having the same reference numerals as those shown in FIG. 2 have the same functions and repetitive description will be therefore omitted.

In the second embodiment, as shown in FIG. 3, a DSP 8 includes synthesizing means 16 as a functional structure to be implemented by a digital signal processing. The synthesizing means 16 synthesizes first control data D_{L} output from first AGC means 14 and second control data D_{I} output from second AGC means 15 to generate control data D, and supplies the control data D to a D/A converting circuit 9. Various methods can be applied to a synthesizing method. For example, it is also possible to add or multiply the first control data D_{L} and the second control data D_{I}. As a matter of course, the other calculations may be executed.

By further synthesizing the second control data D_{I} with the first control data D_{L} and D/A converting the synthesized signal to obtain an AGC control voltage V_{L} of an LNA 3, thus, it is possible to properly control the gain of the LNA 3 in consideration of both a signal level in a narrow band and a signal level in a broad band. For example, in the case in which a signal having a low level of a desirable wave and a very high level of a disturbing wave is input, the level of the desirable wave is reduced together with the disturbing wave so that a receiving sensitivity is deteriorated when the gain of the LNA 3 is controlled based on only the first control data D_{L} generated corresponding to the signal level in the broad band. On the other hand, by controlling the gain of the LNA 3 in consideration of the second control data D_{I} generated corresponding to the signal level in the narrow band as well as the first control data D_{L}, it is possible to prevent the gain of the LNA 3 from being unnecessarily reduced, thereby suppressing a deterioration in the receiving sensitivity. Consequently, an optimum receipt can be carried out.

Although the LNA 3 is taken as an example of the high frequency amplifying circuit in the first and second embodiments, this is not restricted. It is also possible to use an attenuator in place of or in addition to the LNA 3.

Although a band-pass filter having an intermediate pass band is not used in the first and second embodiments, moreover, this may be used. In this case, the band-pass filter in the intermediate band is provided on a front side of the first AGC means 14 (for example, a previous or subsequent stage of the A/D converting circuit 7).

While the description has been given to the example in which the frequency mixing circuit 4, the local oscillating circuit 5 and the antialiasing filter 6 are provided as analog circuits on the outside of the DSP 8 in the first and second embodiments, moreover, it is also possible to implement them through the digital signal processing in the DSP 8. In this case, the A/D converting circuit 7 is provided between the LNA 3 and the frequency mixing circuit 4.

In addition, all of the embodiments are only illustrative for a materialization to carry out the present invention and the technical range of the present invention should not be thereby construed to be restrictive. More specifically, the present invention can be carried out in various forms without departing from the spirit or main features thereof

### INDUSTRIAL APPLICABILITY

The present invention is useful for a receiver having an automatic gain control function for suppressing an occurrence of a signal distortion when a signal having a high level is input. For example, it is possible to apply the present invention to a radio receiver, a television broadcasting receiver and other wireless communication apparatuses.

What is claimed is:

1. A receiver including high frequency amplifying means for amplifying a high frequency signal which is received; frequency converting means for carrying out a frequency conversion for the high frequency signal which is amplified by the high frequency amplifying means, thereby generating an intermediate frequency signal; filter means for carrying out a filter processing for the intermediate frequency signal generated by the frequency converting means, thereby outputting an intermediate frequency signal in a narrow band; intermediate frequency amplifying means for amplifying the intermediate frequency signal in the narrow band which is generated by the filter means; and demodulating means for demodulating the intermediate frequency signal which is amplified by the intermediate frequency amplifying means, comprising:
A/D converting means for analog-digital converting a signal in a broad band or an intermediate band before executing the filter processing through the filter means;
first automatic gain control means for detecting a level of the signal in the broad band or the intermediate band which is output from the A/D converting means, and for generating first control data for controlling a gain of the high frequency amplifying means corresponding to the detected level and outputting the first control data; and
second automatic gain control means for detecting a level of a signal in a narrow band after the filter processing executed by the filter means, and for generating second control data for controlling a gain of the intermediate frequency amplifying means corresponding to the detected level and outputting the second control data,
wherein the gain of the high frequency amplifying means is controlled in such a manner that a voltage input to the A/D converting means is lower than a full scale voltage of the A/D converting means.

2. The receiver according to claim 1, further comprising synthesizing means for synthesizing the first control data output from the first automatic gain control means and the second control data output from the second automatic gain control means,
the first automatic gain control means being controlled based on control data generated by the synthesizing means.

3. A receiver comprising:
a high frequency amplifying circuit for amplifying a high frequency signal which is received;
a frequency converting circuit for carrying out a frequency conversion for the high frequency signal which is amplified by the high frequency amplifying circuit, thereby generating an intermediate frequency signal;
an A/D converting circuit for analog-digital converting the intermediate frequency signal generated by the frequency converting circuit;
a digital signal processing circuit for executing a digital signal processing for the intermediate frequency signal output from the A/D converting circuit and outputting control data for controlling a gain of the high frequency amplifying circuit; and
a D/A converting circuit for digital-analog converting the control data output from the digital signal processing circuit to obtain a control voltage and supplying the control voltage to the high frequency amplifying circuit,
the digital signal processing circuit including:
filter means for executing a filter processing for the intermediate frequency signal output from the A/D converting circuit, thereby outputting an intermediate frequency signal in a narrow band;
intermediate frequency amplifying means for amplifying the intermediate frequency signal subjected to the filter processing through the filter means;
demodulating means for demodulating the intermediate frequency signal which is amplified by the intermediate frequency amplifying means;
first automatic gain control means for detecting a level of the intermediate frequency signal output from the A/D converting circuit, and for generating first control data for controlling the gain of the high frequency amplifying circuit corresponding to the detected level and outputting the first control data; and
second automatic gain control means for detecting a level of a signal after the filter processing executed by the filter means, and for generating second control data for controlling a gain of the intermediate frequency amplifying means corresponding to the detected level and outputting the second control data,
the first control data output from the first automatic gain control means being supplied as the control data to the D/A converting circuit, and
the gain of the high frequency amplifying circuit being controlled in such a manner that a voltage input to the A/D converting circuit is lower than a full scale voltage of the A/D converting circuit.

4. The receiver according to claim 3, wherein the digital signal processing circuit includes synthesizing means for synthesizing the first control data output from the first automatic gain control means and the second control data output from the second automatic gain control means to generate the control data, and supplying the control data thus generated to the D/A converting circuit.
